(19) United States
(12) Patent Application Publication
(10) Pub. No.: US 2023/0360601 A1
(43) Pub. Date: Nov. 9, 2023

(54) DRIVING CIRCUIT AND DRIVING METHOD OF DISPLAY UNIT, AND DISPLAY DEVICE

(71) Applicant: HKC CORPORATION LIMITED, Shenzhen (CN)

(72) Inventors: Yang CHEN, Shenzhen (CN); Huihua LIAO, Shenzhen (CN); Baohong KANG, Shenzhen (CN)

(73) Assignee: HKC CORPORATION LIMITED, Shenzhen (CN)

(21) Appl. No.: 18/092,180

(22) Filed: Dec. 30, 2022

(30) Foreign Application Priority Data
May 7, 2022 (CN) 202210492292.X

(51) Int. Cl. G09G 3/3233

(52) U.S. Cl. CPC G09G 3/3233; G09G 2300/0408; G09G 2300/0452; G09G 2300/08; G09G 2300/0842; G09G 2310/08; G09G 2320/0233

(57) ABSTRACT

Disclosed are driving circuit of a display unit, a driving method of the display unit, and a display device. Driving circuit of the display unit compensates light-emitting circuit 5 at the first connection point A, so that when the light-emitting circuit 5 drives the display unit 6 to emit light, which compensates the light-emitting circuit 5 through the coupling balance circuit 7 to reduce the signal interference caused by the compensation circuit 3 to the first connection point A, and then reduces the voltage fluctuation of the first connection point A. The compensation of the first connection point A to the light emitting circuit 5 is more stable, so that when the light emitting circuit 5 drives the light emitting unit 6, the light emitting unit 6 is more stable, thus improving the display effect of the display unit 6.

### CROSS-REFERENCE TO RELATED APPLICATIONS

This present application claims priority under 35 U.S.C. § 119 to Chinese patent application No. 202210492292.X, filed on May 7, 2022 before the China National Intellectual Property Administration of the People’s Republic of China, entitled “Driving circuit of a display unit, driving method of the display unit, and display device”, the contents of which are explicitly incorporated herein by reference in their entirety.

### FIELD

The present disclosure relates to the field of display panel technology, in particular to a driving circuit of a display unit, a driving method of the display unit, and a display device.

### BACKGROUND

The display panel of the organic light emitting display (OLED), with self-illumination, low driving voltage, high luminous efficiency, short response time, high clarity and contrast, nearly 180° viewing angle, wide use temperature range, flexible display and large-area panchromatic display and many other advantages, is recognized as the most promising display device in the industry.

OLED can be divided into passive matrix (PM) OLED and active matrix (AM) OLED according to the driving mode, namely direct addressing and thin film transistor (TFT) matrix addressing.

At present, in related technologies, when driving OLED through the thin film transistor, due to the parasitic capacitance carried on the TFT device itself, during driving the display unit, it is easy to cause signal interference and voltage fluctuation. When voltage fluctuates, the display brightness of the display unit will fluctuate, resulting in poor display effect.

### SUMMARY

In a first aspect, the present disclosure provides a driving circuit of a display unit, and the driving circuit of the display unit comprises a first reset circuit, a second reset circuit, a compensation circuit, a memory circuit, a light-emitting circuit, and a first connection point. The first reset circuit, the memory circuit, the light-emitting circuit, and the compensation circuit are respectively connected to the first connection point. The light-emitting circuit is used to drive the display unit to emit light. The driving circuit of the display unit further comprises a coupling balance circuit, and one end of the coupling balance circuit is connected between the first reset circuit and the first connection point. The display unit is connected to the light-emitting circuit, and one end of the second reset circuit is connected between the light-emitting circuit and the display unit. The first reset circuit is configured to transmit a reset signal to the first connection point to reset the memory circuit. The second reset circuit is configured to reset the display unit. The compensation circuit is configured to transmit a data signal to the first connection point, so that the memory circuit stores the data signal. The memory circuit is configured to compensate the light-emitting circuit by the first connection point when the compensation circuit stops transmitting the data signal. When the memory circuit compensates the light-emitting circuit by the first connection point, the coupling balance circuit is used to couple the compensation signal to the first connection point. Compensating the first connection point can balance the voltage fluctuation caused by the interference signal coupled to the first connection point when the compensation circuit stops transmitting the data signal.

In a second aspect, the present disclosure provides a driving method of the display unit, and the driving method is applied to the driving circuit of the display unit. the driving circuit of a display unit comprises: a first reset circuit; a second reset circuit; a compensation circuit; a memory circuit; a light-emitting circuit configured to drive a display unit to emit light; a first connection point, wherein the first reset circuit, the memory circuit, the light-emitting circuit, and the compensation circuit are respectively connected to the first connection point; a coupling balance circuit, wherein one end of the coupling balance circuit is connected between the first reset circuit and the first connection point, the display unit is connected to the light-emitting circuit, and one end of the second reset circuit is connected between the light-emitting circuit and the display unit; the first reset circuit is configured to transmit a reset signal to the first connection point to reset the memory circuit, and the second reset circuit is configured to reset the display unit; the compensation circuit is configured to transmit a data signal to the first connection point so that the memory circuit stores the data signal, and the memory circuit is configured to compensate the light-emitting circuit using the data signal through the first connection point when the compensation circuit stops transmitting the data signal; the coupling balance circuit is configured to couple a compensation signal to the first connection point to compensate the first connection point when the memory circuit compensates the light-emitting circuit through the first connection point, thereby balancing a voltage fluctuation caused by an interference signal coupled to the first connection point when the compensation circuit stops transmitting the data signal; the driving method comprises:
in a reset stage, a reset signal is transmitted to a first connection point through a first reset circuit, to reset a memory circuit, and a display unit is reset by a second reset circuit;
in a compensation stage, a data signal is transmitted to the first connection point by a compensation circuit so that the memory circuit stores the data signal; and when the compensation circuit stops transmitting the data signal, the data signal is transmitted to the first connection point by the memory circuit, and the data signal is used to compensate a light-emitting circuit;
in a light-emitting stage, the display unit is driven by the light-emitting circuit to emit light; and when the memory circuit compensates the light-emitting circuit through the first connection point, the first connection point is compensated by coupling a compensation signal to the first connection point through a coupling balance circuit, thereby balancing a voltage fluctuation caused by an interference signal coupled to the first connection point when the compensation circuit stops transmitting the data signal.

In a third aspect, the present disclosure provides a display device comprising: a substrate; a plurality of sub-pixels on the substrate, wherein each of the plurality of sub-pixel comprises a display unit and a driving circuit of the display unit, and the driving circuit of the display unit is connected to the display unit, the driving circuit of a display unit comprises: a first reset circuit; a second reset circuit; a compensation circuit; a memory circuit; a light-emitting circuit configured to drive a display unit to emit light; a first connection point, wherein the first reset circuit, the memory circuit, the light-emitting circuit, and the compensation circuit are respectively connected to the first connection point; a coupling balance circuit, wherein one end of the coupling balance circuit is connected between the first reset circuit and the first connection point, the display unit is connected to the light-emitting circuit, and one end of the second reset circuit is connected between the light-emitting circuit and the display unit; the first reset circuit is configured to transmit a reset signal to the first connection point to reset the memory circuit, and the second reset circuit is configured to reset the display unit; the compensation circuit is configured to transmit a data signal to the first connection point so that the memory circuit stores the data signal, and the memory circuit is configured to compensate the light-emitting circuit using the data signal through the first connection point when the compensation circuit stops transmitting the data signal; the coupling balance circuit is configured to couple a compensation signal to the first connection point to compensate the first connection point when the memory circuit compensates the light-emitting circuit through the first connection point, thereby balancing a voltage fluctuation caused by an interference signal coupled to the first connection point when the compensation circuit stops transmitting the data signal.

The driving circuit of the display unit in an embodiment of the present disclosure comprises the first reset circuit, the second reset circuit, the compensation circuit, the memory circuit, the coupling balance circuit, the light-emitting circuit, and the first connection point. The first reset circuit, the memory circuit, the light-emitting circuit, and the compensation circuit are respectively connected to the first connection point. One end of coupling balance circuit is connected i between the first reset circuit and the first connection point. The display unit is connected to the light-emitting circuit, and one end of the second reset circuit is connected between the light-emitting circuit and the display unit. The first reset circuit is configured to transmit the reset signal to the first connection point to reset the memory circuit, and the second reset circuit is configured to reset the display unit. The compensation circuit is configured to transmit the data signal to the first connection point so that the memory circuit stores the data signal. The memory circuit is configured to compensate the light-emitting circuit by the data signal through the first connection point when the compensation circuit stops transmitting the data signal. The light-emitting circuit is used to drive the display unit to emit light. When the memory circuit compensates the light-emitting circuit through the first connection point, the coupling balance circuit is configured to compensate the first connection point by coupling the compensation signal to the first connection point, thereby balancing the voltage fluctuation caused by the interference signal coupled to the first connection point when the compensation circuit stopping transmitting the data signal. By compensating the light-emitting circuit at the first connection point, the light-emitting circuit is compensated by the coupling balance circuit when the light-emitting circuit drives the display unit to emit light, thereby reducing the signal interference caused by the compensation circuit to the first connection point, and reducing the voltage fluctuation of the first connection point. Thus, the compensation of the first connection point to the light-emitting circuit is more stable, and the light-emitting of the display unit is more stable when the light-emitting circuit drives the display unit to emit light, thereby improving the display effect of the display unit. When the display effect of the display unit is improved, the display effect of the display device comprising the display unit is improved.

### BRIEF DESCRIPTION OF THE DRAWINGS

FIG. 1 is a schematic view of a basic structure of the driving circuit of the display unit provided in Embodimen 1 of the present disclosure;

FIG. 2 is a basic schematic view of the driving circuit of an optional display unit provided in Embodimen 1 of the present disclosure;

FIG. 3 is a basic schematic view of the driving circuit of another optional display unit provided in Embodimen 1 of the present disclosure;

FIG. 4 is a flow chart of a driving method of the display unit provided in Embodimen 2 of the present disclosure;

FIG. 5 is a timing diagram of each signal in the driving circuit of an optional display unit in Embodimen 3 of the present disclosure;

FIG. 6 is a basic schematic view of the driving circuit of an optional display unit provided provided in Embodimen 3 of the present disclosure;

FIG. 7 is a schematic view of a basic structure of a display device provided in Embodimen 4 of the present disclosure; and

FIG. 8 is a schematic view of a display equipment provided in Embodimen 5 of the present disclosure.

Description of the drawings markers:

1 - first reset circuit; 2 - second reset circuit; 3 - compensation circuit; 31 - first compensation circuit; 32 - second compensation circuit; 4 -memory circuit; 5 - light-emitting circuit; 6 - display unit; 7-coupling balance circuit; 8-substrate; 9 - subpixel; 10 - driving circuit of the display unit; C1 -parasitic capacitance; C2 - compensation capacitance; T1 - first thin film transistor; T2 - second thin film transistor; T3 - third thin film transistor; T4 -fourth thin film transistor; T5 - fifth thin film transistor; T6 - sixth thin film transistor; T7 - seventh thin film transistor; A - first connection point; B - second connection point; C - third connection point; Vref - reference voltage; Emit -light-emitting control signal; S1[n]- first scanning signal; S2[n]- second scanning signal; S1[n+1] - first scanning signal of the next frame; PVDD - high voltage signal input terminal; PVEE - low voltage signal input terminal; Vdata - data signal.

### DETAILED DESCRIPTION

In order to make the purpose, technical solution and advantages of the embodiment of the present disclosure clearer, the following will be combined with the drawings in the embodiment of the present disclosure, the technical solution in the embodiment of the present disclosure is clearly and completely described. Obviously, the embodiment described is part of the embodiment of the present disclosure, not all embodiments. Based on embodiments in the present disclosure, all other embodiments obtained by one of ordinary skill in the art without creative work fall within the scope of protection of the present disclosure.

For the sake of brevity, only the parts related to the present disclosure are shown schematically in each drawing and they do not represent the actual structure of the product. In addition, to make the drawing concise and easy to understand, in some drawings only one of the parts with the same structure or function is graphically drawn, or only one of the parts is marked. In this article, “one” means not only “one” but also “multiple one” cases.

The present disclosure is described in further detail below in conjunction with the attached drawings and embodiments.

### First Embodiment

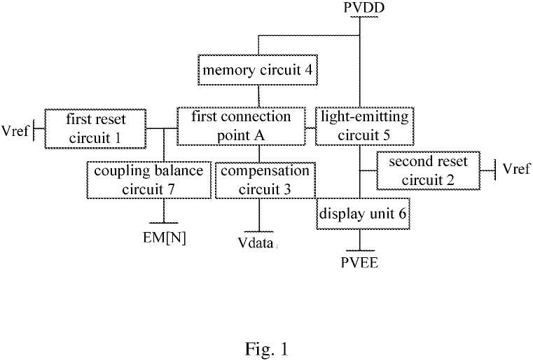

Referring to FIG. 1, FIG. 1 is a schematic view of a driving circuit of a display unit provided in an embodiment of the present disclosure, the driving circuit of the display unit comprises but is not limited to: a first reset circuit 1, a second reset circuit 2, a compensation circuit 3, a memory circuit 4, a coupling balance circuit 7, a light-emitting circuit 5, and a first connection point A.

The first reset circuit 1, the memory circuit 4, the light-emitting circuit 5, and the compensation circuit 3 are respectively connected to the first connection point A. One end of coupling balance circuit 7 is connected between the first reset circuit 1 and the first connection point A. The display unit 6 is connected to the light-emitting circuit 5, and one end of the second reset circuit 2 is connected in parallel between the light-emitting circuit 5 and the display unit 6.

The first reset circuit 1 is configured to transmit a reset signal to the first connection point A to reset the memory circuit 4, and the second reset circuit 2 is configured to reset the display unit 6.

The compensation circuit 3 is configured to transmit the data signal Vdata to the first connection point A, so that the memory circuit 4 stores the data signal Vdata. The memory circuit 4 is configured to compensate the light-emitting circuit 5 using the data signal Vdata through the first connection point A when the compensation circuit 3 stops transmitting the data signal Vdata.

The light-emitting circuit 5 is configured to drive the display unit 6 to emit light.

The coupling balance circuit 7 is configured to couple the compensation signal to the first connection point A to compensate the first connection point A when the memory circuit 4 compensates the light-emitting circuit 5 through the first connection point A, thereby balancing the voltage fluctuation caused by the interference signal coupled to the first connection point A when the compensation circuit 3 stops transmitting the data signal Vdata.

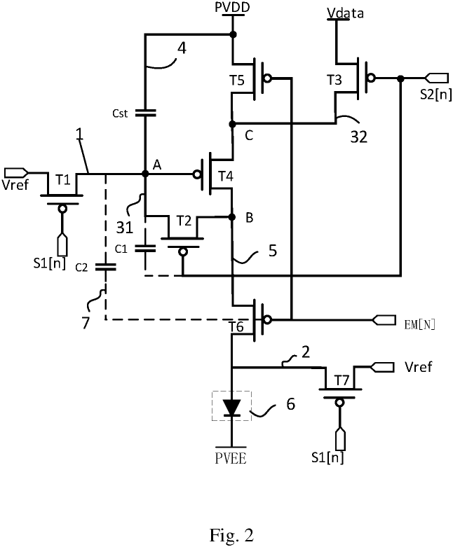

As shown in FIG. 2, one end of the first reset circuit 1 is connected to the reference voltage Vref, and the other end of the first reset circuit 1 is connected to the first connection point A. One end of the second reset circuit 2 is connected to the reference voltage Vref, and the other end of the second reset circuit 2 is connected between the light-emitting circuit 5 and the display unit 6. One end of the light-emitting circuit 5 is connected to the high voltage signal input terminal, and the other end of the light-emitting circuit 5 is connected to the anode of the display unit 6. The cathode of the display unit 6 is connected to the low voltage signal input terminal. One end of the compensation circuit 3 is connected to the data signal Vdata, the other end of the compensation circuit 3 is connected to the first connection point A, and at least one thin film transistor is provided on the compensation circuit 3.

It should be understood that the driving circuit of the display unit comprises three working stages: a reset stage, a compensation stage, and a light-emitting stage.

During the reset stage, the first reset circuit 1 transmits the reference voltage Vref as the reset signal to the first connection point A, to reset the memory circuit 4. The second reset circuit 2 takes the reference voltage Vref as the reset signal to reset the display unit 6.

During the compensation stage, the thin film transistor on the compensation circuit 3 is turned on, and the data signal Vdata connected by the compensation circuit 3 is transmitted to the first connection point A, so that the memory circuit 4 stores the data signal Vdata, and when the driving circuit of the display unit is in the light-emitting stage, the data signal Vdata is output to the first connection point A to compensate the light-emitting circuit 5.

During the light-emitting stage, the light-emitting circuit 5 drives the display unit 6 to emit light. When the compensation circuit 3 is cut off, because the thin film transistor present on the compensation circuit 3 carries a parasitic capacitance C1, the parasitic capacitance C1 will couple the signal of the thin film transistor on the cut-off compensation circuit 3 to the first connection point A, and the signal coupled to the first connection point A will cause the voltage signal of the first connection point A to fluctuate, resulting in fluctuation in the compensation of the light-emitting circuit 5. At this time, according to coupling the compensation signal to the first connection point A by the coupling balance circuit 7, the first connection point A is compensated, thereby balancing the voltage fluctuation caused by the parasitic capacitance C1 present on the compensation circuit 3 coupled to the interference signal of the first connection point A. That is, the electrode polarity of the compensation signal coupled to the first connection point A by the coupling balance circuit 7 is opposite to the electrode polarity of the signal of the thin film transistor on the cut-off compensation circuit 3.

In some embodiments, the light-emitting circuit 5 is configured to turn on according to the light-emitting control signal Emit of the first polarity that is output by the light-emitting control signal circuit, to drive the display unit 6 to emit light. The compensation circuit 3 is configured to turn on according to the second scanning signal S2[n] of the first polarity that is output by the second scanning signal circuit. The compensation circuit 3 is cut off according to the second scanning signal S2[n] of the second polarity that is output by the second scanning signal circuit. When the compensation circuit 3 is cut off, the second scanning signal S2[n] of the second polarity that is output by the second scan signal circuit is coupled to the first connection point A. The coupling balance circuit 7 comprises a compensation capacitance C2. The compensation capacitance C2 is used to couple the light-emitting control signal Emit of the first polarity that is output by the light-emitting control signal circuit, to the first connection point A as a compensation signal, thereby balancing the voltage fluctuation caused by the compensation circuit 3 couples the second scanning signal S2[n] of the second polarity that is output by the second scanning signal circuit to the the first connection point A. The light-emitting control signal Emit of the first polarity that is output by the light-emitting control signal circuit and the second scanning signal S2[n] of the second polarity that is output by the second scanning signal circuit are signals with opposite electrode polarity.

In some embodiments, as shown in FIG. 2, the compensation circuit 3 is configured to turn on according to the second scanning signal S2[n] of the first polarity that is output by the second scanning signal circuit. That is, when the second scanning signal circuit outputs the second scanning signal S2[n] of the first polarity, the compensation circuit 3 is turned on. When the second scanning signal circuit outputs the second scanning signal S2[n] of the second polarity, the compensation circuit 3 is cut off. The light-emitting circuit 5 is configured to turn on according to the light-emitting control signal Emit of the first polarity that is output by the light-emitting control signal circuit. That is, when the light-emitting control signal circuit outputs the light-emitting control signal Emit of the first polarity, the light-emitting circuit 5 is turned on. When the light-emitting control signal circuit outputs the light-emitting control signal Emit of the second polarity, the light-emitting circuit 5 is cut off. The light-emitting control signal Emit of the first polarity that is output by the light-emitting control signal circuit and the second scanning signal S2[n] of the second polarity that is output by the second scanning signal circuit are signals with opposite electrode polarity. For example, when the light-emitting control signal Emit of the first polarity that is output by the light-emitting control signal circuit is a low level signal, the second scanning signal S2[n] of the second polarity that is output by the second scanning signal circuit is a high level signal. Or when the light-emitting control signal Emit of the first polarity that is output by the light-emitting control signal circuit is the high level signal, the second scanning signal S2[n] of the second polarity that is output by the second scanning signal circuit is the low level signal. Thus, the compensation capacitance C2 couples the light-emitting control signal Emit of the first polarity that is output by the light-emitting control signal circuit, to the first connection point A as the compensation signal, and can balance the voltage fluctuation caused by the compensation circuit 3 couples the second scanning signal S2[n] of the second polarity that is output by the second scanning signal circuit to the first connection point A.

In some embodiments, as shown in FIG. 2, the compensation circuit 3 comprises a first compensation circuit 31 and a second compensation circuit 32. The node connecting the first compensation circuit 31 and the light-emitting circuit 5 is the second connection point B. The node connecting the second compensation circuit 32 and the light-emitting circuit 5 is the third connection point C. The second compensation circuit 32 is configured to transmit the data signal Vdata to the third connection point C, to transmit to the second connection point B through the light-emitting circuit 5. The first compensation circuit 31 is configured to transmit the data signal Vdata from the second connection point B to the first connection point A.

That is, the connection between the first compensation circuit 31 and the second compensation circuit 32 is realized by multiplexing part of the light-emitting circuit 5. The second compensation circuit 32 transmits the data signal Vdata to the second connection point B, and multiplexes part of the light-emitting circuit 5, thereby transmiting the data signal Vdata to the second connection point B. The first compensation circuit 31 receives the data signal Vdata from the second connection point B, and then transmits the data signal Vdata to the first connection point A. The data signal Vdata is transmitted to the memory circuit 4 through the first connection point A. It can be understood that when transmitted to the first connection point A, the data signal Vdata is synchronously transmitted to the light-emitting circuit 5. By multiplexing part of the light-emitting circuit 5, the circuit in the driving circuit of the display unit is reduced, the volume of the driving circuit of the display unit is reduced, and the circuit structure design can be simplified, thereby increasing the pixel opening rate and improving the display effect.

In some embodiments, as shown in FIG. 2, the light-emitting circuit 5 comprises a fourth thin film transistor T4, a fifth thin film transistor T5, and a sixth thin film transistor T6. The control terminal of the fourth thin film transistor T4 is connected to the first connection point A. The first end of the fourth thin film transistor T4 is connected to the third connection point C, and the second end of the fourth thin film transistor T4 is connected to the second connection point B. The control terminal of the fifth thin film transistor T5 and the sixth thin film transistor T6 are connected to the light-emitting control signal circuit. The first end of the fifth thin film transistor T5 is connected to the high voltage signal input terminal PVDD, and the second end of the fifth thin film transistor T5 is connected to the third connection point C. The first end of the sixth thin film transistor T6 is connected to the second connection point B, and the second end of the sixth thin film transistor T6 is connected to the display unit 6. When the fourth thin film transistor T4, the fifth thin film transistor T5, and the sixth thin film transistor T6 are turned on, the current flows from the high voltage signal input terminal PVDD to the low voltage signal input terminal PVEE that is connected to the display unit 6, thereby driving the display unit 6 to emit light.

Wherein, in the reset stage, the first reset circuit 1 outputs the reference voltage Vref to the first connection point A, the memory circuit 4 is charged and reset. At the same time, the first connection point A writes the reference voltage Vref to the control terminal of the fourth thin film transistor T4, and the reference voltage Vref can turn on the fourth thin film transistor T4. In the reset stage, the second reset circuit 2 resets the display unit 6 through the reference voltage Vref.

In the compensation stage, since the first connection point A writes the reference voltage Vref to the control terminal of the fourth thin film transistor T4, the fourth thin film transistor T4 is in the on state. The compensation circuit 3 multiplexes the fourth thin film transistor T4 in the light-emitting circuit 5, and transmits the data signal Vdata to the first connection point A. The first connection point A transmits the data signal Vdata to the memory circuit 4, and at the same time transmits the data signal Vdata to the control terminal of the fourth thin film transistor T4. The voltage Vgs of the gate of the fourth thin film transistor T4 relative to the source stage is equal to the voltage V_A of the first connection point A subtracts the voltage Vdat of the data signal Vdata. That is, Vgs = V_A-Vdata. When Vgs is equal to the threshold voltage Vth of the control terminal, that is, when Vgs=V_A-Vdata = Vth, the fourth thin-film transistor T4 is turned off, and at this time, the voltage V_A of the first connection point A is equal to Vdata plus Vth.

In the light-emitting stage, the memory circuit 4 outputs the data signal Vdata to the first connection point A, so that the voltage of the first connection point AV_A is maintained as Vdata+Vth. That is, the voltage transmitted by the first connection point A to the control terminal of the fourth thin film transistor T4 is Vdata+Vth, so that the fourth thin film transistor T4 is turned on, and the light-emitting control signal Emit of the first polarity that is output by the light-emitting control signal circuit turns on the fifth thin film transistor T5 and the sixth thin film transistor T6. The voltage at the first end of the fourth thin film transistor T4 is PVDD. At the same time, the compensation capacitance C2 couples the light-emitting control signal Emit of the first polarity that is output by the light-emitting control signal circuit to the first connection point A as a compensation signal, thereby balancing the voltage fluctuation caused by coupling the second scanning signal S2[n] of the second polarity that is output by the second scanning signal circuit, to the first connection point A by the compensation circuit 3. Thus, the current flowing through the fourth thin film transistor T4 is defined as I,

and I = ½ *K (Vgs-Vth) ^2= ½ *K (Vdata+Vth-PVDD-Vth) ^ 2= ½* K(Vdata-PVDD)^ 2, so that the final driving current flowing through the display unit 6 is independent of the Vth of the fourth thin film transistor T4, which has a compensation effect.

In some embodiments, the first reset circuit 1 comprises a first thin film transistor T1, and the control terminal of the first thin film transistor T1 is connected to the first scanning signal circuit. The first end of the first thin film transistor T1 is connected to the reference voltage Vref, and the second end of the first thin film transistor T1 is connected to the first connection point A. When the first thin film transistor T1 is turned on, the reference voltage Vref is transmitted to the first connection point A, to reset the memory circuit 4 and the light-emitting circuit 5. The second reset circuit 2 comprises a seventh thin film transistor T7, and the control terminal of the seventh thin film transistor T7 is connected to the first scanning signal circuit. The first end of the seventh thin film transistor T7 is connected to the reference voltage Vref, and the second end of the seventh thin film transistor T7 is connected in parallel between the light-emitting circuit 5 and the display unit 6. When the seventh thin film transistor T7 is turned on, the reference voltage Vref is transmitted to the display unit 6 to reset the display unit 6.

It can be understood that when the second reset circuit 2 resets the display unit 6, the reference voltage Vref is output to the anode of the display unit 6, so that the voltage of the anode of the display unit 6 is lower than the voltage of the cathode of the display unit 6, to reset the display unit 6. In some embodiments, when the reference voltage Vref is a low level voltage, the seventh thin film transistor T7 in the second reset circuit 2 is turned on, and the reference voltage Vref flows to the anode of the display unit 6, thereby making the voltage of the anode of the display unit 6 lower than the voltage of the cathode of the display unit 6, and realizing the reset of the display unit 6.

In some embodiments, if the reference voltage Vref is a high level voltage, a reverser is also provided between the second end of the seventh thin film transistor T7 and the display unit 6. Thus, when the reference voltage Vref is transmitted in the second reset circuit 2, the high level reference voltage Vref is reversed, and the low level reference voltage Vref is transmitted to the anode of the display unit 6, so that the voltage of the anode of the display unit 6 is lower than the voltage of the cathode of the display unit 6, thereby realizing the reset of the display unit 6.

In some embodiments, the first compensation circuit 31 comprises a second thin film transistor T2, and the control terminal of the second thin film transistor T2 is connected to the second scanning signal circuit. The first end of the second thin film transistor T2 is connected to the second connection point B, and the second end of the second thin film transistor T2 is connected to the first connection point A. When the first compensation circuit 31 is turned on, the data signal Vdata is transmitted from the second connection point B to the first connection point A. The second compensation circuit 32 comprises a third thin film transistor T3, and the control terminal of the third thin film transistor T3 is connected to the second scanning signal circuit. The first end of the third thin film transistor T3 is connected to the data signal Vdata, and the second end of the third thin film transistor T3 is connected to the third connection point C. When the second compensation circuit 32 is turned on, the data signal Vdata is transmitted to the third connection point C.

It can be understood that, wherein the first scanning circuit is the circuit corresponding to the Nth scanning line, and the second scanning signal circuit is the circuit corresponding to the (N+1)th scanning line. The scanning direction of the present embodiment is from the first line to the last line, that is, the first scanning signal S1[n] and the second scanning signal S2[n] are scanned sequentially.

The present embodiment does not limit the type of second thin film transistor T2 and third thin film transistor T3, and the type of second thin film transistor T2 and third thin film transistor T3 can be flexibly set according to actual needs.

In some embodiments, the memory circuit 4 is provided with a storage capacitance Cst, and the storage capacitance Cst is used to store the data signal Vdata.

It should be understood that the light-emitting control signal circuit can output the light-emitting control signal Emit of the first polarity or the light-emitting control signal Emit of the second polarity. The first scanning signal circuit can output the first scanning signal of the first polarity or the first scanning signal of the second polarity. The second scanning signal circuit can output the second scanning signal of the first polarity or the second scanning signal of the second polarity, and the first polarity and the second polarity are opposite polarities. For example, the first polarity is high and the second polarity is low; for another example, the first polarity is low and the second polarity is high, and the level of the signal output by each circuit can change with demand. At the same time, the data signal Vdata and the reference voltage Vref can be high or low, that is, the data signal Vdata and the reference voltage Vref are set according to the actual needs.

In some embodiments, in one embodiment, the first to seventh thin film transistors T1-T7 are all N-type thin film transistors, the data signal Vdata and the reference voltage Vref are high, the first polarity is high, and the second polarity is low. Taking a frame of the light-emitting signal as a cycle, a frame signal is divided into T1, T2, and T3 periods, the T1 period corresponds to the reset stage, the T2 period corresponds to the compensation stage, and the T3 period corresponds to the light-emitting stage.

In the T1 reset stage, the first scanning signal circuit outputs the first scanning signal S1[n] of the first polarity, the first thin film transistor T1 is turned on, so that the first reset circuit 1 responds to the reference voltage Vref, and the reference voltage Vref is transmitted to the first connection point A to reset the memory circuit 4. It can be understood that when the memory circuit 4 is reset, the first reset circuit 1 also responds to the reference voltage Vref to reset the fourth thin film transistor T4, and the fourth thin film transistor T4 is turned on. The second reset circuit 2 also response to the reference voltage Vref to reset the display unit 6. The second scanning signal circuit outputs the second scanning signal S2[n] of the second polarity, so that the second thin film transistor T2 and the third thin film transistor T3 are in the cut-off state, and the compensation circuit 3 does not work. The light-emitting control signal circuit outputs the light-emitting control signal Emit of the second polarity, thereby making the fifth thin film transistor T5 and the sixth thin film transistor T6 in the cut-off state, and the light-emitting circuit 5 does not work.

In the T2 compensation stage, the first scanning signal circuit outputs the first scanning signal S1[n] of the second polarity, and the first thin film transistor T1 is cut off. The second scanning signal circuit outputs the light-emitting control signal Emit of the first polarity, so that the second thin film transistor T2 and the third thin film transistor T3 are in the on state, and the compensation circuit 3 works and transmit the data signal Vdata to the first connection point A, so that the fourth thin film transistor T4 is in the on state. The light-emitting control signal circuit continues to output the light-emitting control signal Emit of the second polarity, so that the fifth thin film transistor T5 and the sixth thin film transistor T6 are in the cut-off state, and the light-emitting circuit 5 does not work.

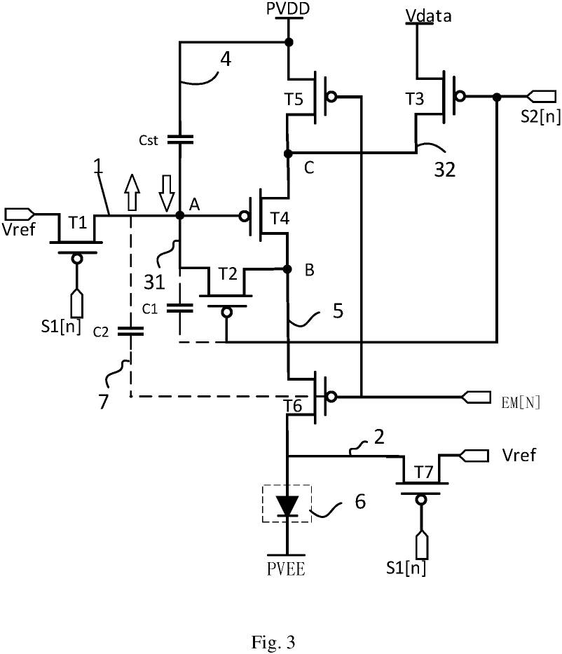

In the T3 light-emitting stage, the first scanning signal circuit outputs the first scanning signal S1[n] of the second polarity, and the first thin film transistor T1 is cut off. The second scanning signal circuit outputs the second scanning signal S2[n] of the second polarity, so that the second thin film transistor T2 and the third thin film transistor T3 are in the cut-off state, and the compensation circuit 3 does not work, as shown in FIG. 3. When the compensation circuit 3 does not work, the parasitic capacitance C1 carried by the second thin film transistor T2 itself couples the second scanning signal S2[n] of the second polarity that is output by the second scanning signal circuit, to the first connection point A, resulting in downward fluctuation in the voltage of the first connection point A. The compensation capacitance C2 couples the light-emitting control signal Emit of the first polarity that is output by the light-emitting control signal circuit, to the first connection point A, thereby balancing the fluctuation caused by the parasitic capacitance C1. At the same time, the memory circuit 4 outputs the data signal Vdata as a compensation signal to the first connection point A, to continuously turn on the fourth thin film transistor T4. The light-emitting control signal circuit outputs the light-emitting control signal Emit of the first polarity, so that the fifth thin film transistor T5 and the sixth thin film transistor T6 are in the on state, and the light-emitting circuit 5 works and drives the display unit 6 to perform light-emitting display.

The driving circuit of the display unit provided in this embodiment, comprising but not limited to: the first reset circuit 1, the second reset circuit 2, the compensation circuit 3, the memory circuit 4, the coupling balance circuit 7, the light-emitting circuit 5, and the first connection point A. The first reset circuit 1, the memory circuit 4, the light-emitting circuit 5, and the compensation circuit 3 are respectively connected to the first connection point A. The coupling balance circuit 7 is connected in parallel between the first reset circuit 1 and the first connection point A. The display unit 6 is connected to the light-emitting circuit 5, and the second reset circuit 2 is connected in parallel between the light-emitting circuit 5 and the display unit 6. The first reset circuit 1 is configured to transmit the reset signal to the first connection point A to reset the memory circuit 4, and the second reset circuit 2 is configured to reset the display unit 6. The compensation circuit 3 is configured to transmit the data signal Vdata to the first connection point A, so that the memory circuit 4 stores the data signal Vdata. The memory circuit 4 is configured to compensate the light-emitting circuit 5 using the data signal Vdata through the first connection point A when the compensation circuit 3 stops transmitting the data signal Vdata. The light-emitting circuit 5 is configured to drive the display unit 6 to emit light. The coupling balance circuit 7 is configured to couple the compensation signal to the first connection point A and compensate the first connection point A when the memory circuit 4 compensates the light-emitting circuit 5 by the first connection point A, thereby balancing the voltage fluctuation caused by the interference signal coupled to the first connection point A when the compensation circuit 3 stops transmitting the data signal Vdata. By compensating the light-emitting circuit at the first connection point A, when the light-emitting circuit 5 drives the display unit to emit light, the light-emitting circuit 5 is compensated by the coupling balance circuit 7, the signal interference caused by the compensation circuit 3 to the first connection point A is reduced, and the voltage fluctuation of the first connection point A is reduced, so that the compensation of the first connection point A to the light-emitting circuit 5 is more stable, and the light-emitting light of the display unit is more stable when the light-emitting circuit 5 drives the display unit to emit light, thereby improving the display effect of the display unit.

### Second Embodiment

The embodiment of the present disclosure provides a driving method of the display unit, and the method is applied to the driving circuit of the display unit. The driving circuit of the display unit comprises but is not limited to: a first reset circuit 1; a second reset circuit 2; a compensation circuit 3; a memory circuit 4; a coupling balance circuit 7, a light-emitting circuit 5 and a first connection point A; wherein the first reset circuit 1, the memory circuit 4, the light-emitting circuit 5, and the compensation circuit 3 are respectively connected to the first connection point A; wherein one end of the coupling balance circuit 7 is connected between the first reset circuit 1 and the first connection point A, the display unit 6 is connected to the light-emitting circuit 5, and one end of the second reset circuit 2 is connected between the light-emitting circuit 5 and the display unit 6; the first reset circuit 1 is configured to transmit a reset signal to the first connection point A to reset the memory circuit 4, and the second reset circuit 2 is configured to reset the display unit 6; the compensation circuit 3 is configured to transmit a data signal Vdata to the first connection point A so that the memory circuit 4 stores the data signal Vdata, and the memory circuit 4 is configured to compensate the light-emitting circuit 5 using the data signal Vdata through the first connection point A when the compensation circuit 3 stops transmitting the data signal Vdata; the light-emitting circuit 5 is configured to drive the display unit 6 to emit light; the coupling balance circuit 7 is configured to couple a compensation signal to the first connection point A to compensate the first connection point A when the memory circuit 4 compensates the light-emitting circuit 5 through the first connection point A, thereby balancing a voltage fluctuation caused by an interference signal coupled to the first connection point A when the compensation circuit 3 stops transmitting the data signal Vdata.

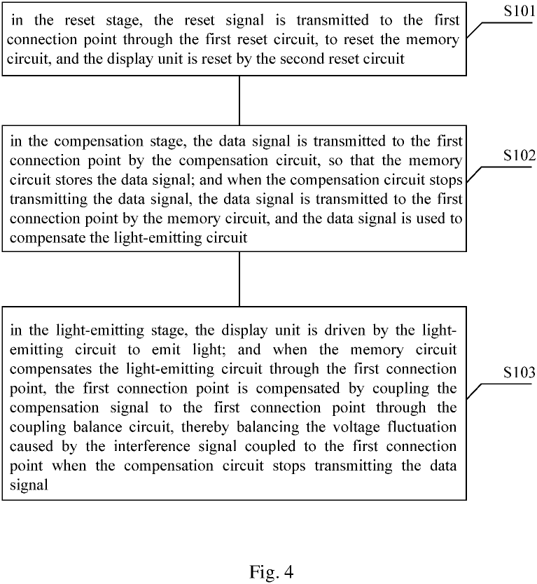

As shown in FIG. 4, the method comprises:
S101, in the reset stage, the reset signal is transmitted to the first connection point through the first reset circuit, to reset the memory circuit, and the display unit is reset by the second reset circuit;
S102, in the compensation stage, the data signal is transmitted to the first connection point by the compensation circuit, so that the memory circuit stores the data signal; and when the compensation circuit stops transmitting the data signal, the data signal is transmitted to the first connection point by the memory circuit, and the data signal is used to compensate the light-emitting circuit; and
S103, in the light-emitting stage, the display unit is driven by the light-emitting circuit to emit light; and when the memory circuit compensates the light-emitting circuit through the first connection point, the first connection point is compensated by coupling the compensation signal to the first connection point through the coupling balance circuit, thereby balancing the voltage fluctuation caused by the interference signal coupled to the first connection point when the compensation circuit stops transmitting the data signal.

In some embodiments, resetting the display unit through the second reset circuit comprises: resetting the display unit by providing the high level signal to the anode of the display unit through the second reset circuit.

In some embodiments, the reset stage comprises a first reset stage and a second reset stage, and the first reset stage and the second reset stage are different time periods. There is an interval time period between the time period corresponding to the first reset stage and the time period corresponding to the second reset stage. Wherein, in the first reset stage, the driving circuit of the display unit transmits the reset signal to the first connection point through the first reset circuit, to reset the memory circuit; and in the second reset stage, the driving circuit of the display unit resets the display unit through the second reset circuit.

In some embodiments, the reset stage comprises the first reset stage and the second reset stage, and the first reset stage and the second reset stage are different time periods. There is no interval time period between the time period corresponding to the first reset stage and the time period corresponding to the second reset stage. That is, the first reset stage and the second reset stage are continuous. Wherein in the first reset stage, the driving circuit of the display unit transmits the reset signal to the first connection point through the first reset circuit to reset the memory circuit; and in the second reset stage, the driving circuit of the display unit resets the display unit through the second reset circuit.

In some embodiments, the reset stage is only a time period. During the reset stage, the driving circuit of the display unit transmits the reset signal to the first connection point through the first reset circuit, and the driving circuit of the display unit resets the display unit through the second reset circuit.

In some embodiments, the compensation signal is coupled to the first connection point by the coupling balance circuit, and the first connection point is compensated to balance the voltage fluctuations caused by the interference signal coupled to the first connection point when the compensation circuit stops transmitting the data signal. And the step that the compensation signal is coupled to the first connection point by the coupling balance circuit comprises that: through the coupling balance circuit, the light-emitting control signal of the first polarity that is output by the light-emitting control signal circuit is coupled to the first connection point as the compensation signal, thereby balancing the voltage fluctuations caused by coupling the second scanning signal of the second polarity that is output by the second scanning signal circuit to the first connection point by the compensation circuit. The light-emitting control signal of the first polarity that is output by the light-emitting control signal circuit and the second scanning signal of the second polarity that is output by the second scanning signal circuit are signals with opposite electrode polarity.

### Third Embodiment

In order to better understand the present disclosure, the present embodiment provides a more specific example of the driving method of the display unit. In some embodiments, the driving circuit of the display unit comprises seven thin film transistors, and the first thin film transistor T1 to the seventh thin film transistor T7 are P-type thin film transistors. At this time the reference voltage Vref is a low voltage, the data signal Vdata is a low voltage, the first polarity is a low level, and the second polarity is a high level. Taking a frame of light-emitting signal as a cycle, and the frame signal is divided into four periods of T1, T2, T3, T4. T1 period corresponds to the stage of resetting by the first reset circuit 1, T2 period corresponds to the compensation phase, T3 period corresponds to the stage of resetting by second reset circuit 2, and T4 period corresponds to the light-emitting stage. It should be understood that there can be an interval time period between T1, T2, T3, T4 periods; and T1, T2, T3, and T4 can also be continuous without interval.

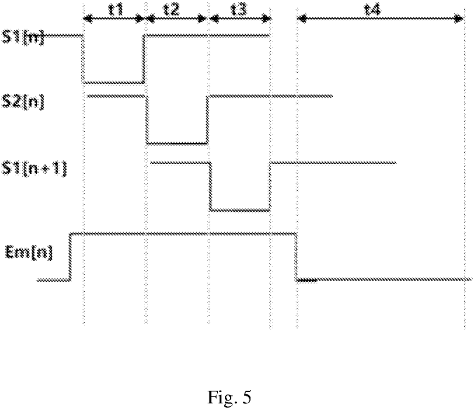

As shown in FIG. 5, FIG. 5 shows the timing diagram of each signal. During the T1 reset stage, the first scanning signal circuit outputs the first scanning signal S1[n] of the first polarity, turns on the first thin film transistor T1, so that the first reset circuit 1 responds to the reference voltage Vref, transmits the reference voltage Vref to the first connection point A, and resets the memory circuit 4. It can be understood that when the memory circuit 4 is reset, the first reset circuit 1 also resets the fourth thin film transistor T4 in response to the reference voltage Vref, so that the control terminal of the fourth thin film transistor T4 writes the reference voltage Vref and turns on the fourth thin film transistor T4. The second scanning signal circuit outputs the second scanning signal S2[n] of the second polarity, so that the second thin film transistor T2 and the third thin film transistor T3 are in the cut-off state, and the compensation circuit 3 does not work. The light-emitting control signal circuit outputs the light-emitting control signal Emit of the second-polarity, thereby making the fifth thin film transistor T5 and the sixth thin film transistor T6 in the cut-off state, and the light-emitting circuit 5 does not work.

In the T2 compensation stage, the first scanning signal circuit outputs the first scanning signal S1[n] of the second polarity, and the first thin film transistor T1 is cut off. The second scanning signal circuit outputs the light-emitting control signal Emit of the first polarity, so that the second thin film transistor T2 and the third thin film transistor T3 are in the on state, and the compensation circuit 3 works to transmit the data signal Vdata to the first connection point A, and the fourth thin film transistor T4 is in the on state. The light-emitting control signal circuit continues to output the light-emitting control signal Emit of the second polarity, so that the fifth thin film transistor T5 and the sixth thin film transistor T6 are in the cut-off state, and the light-emitting circuit 5 does not work. In this process, the second thin film transistor T2 and the third thin film transistor T3 are turned on. Because the control terminal of the fourth thin film transistor T4 in the T1 stage is written with a reference voltage Vref, the initial state of the fourth thin film transistor T4 is open at this time. In this process, the data signal Vdata is transmitted to the first connection point A through the third thin film transistor T3, the fourth thin film transistor T4 and the second thin film transistor T2; and then the data signal Vdata is transmitted to the control terminal of the fourth thin film transistor T4, and the voltage of the control terminal of the fourth thin film transistor T4 will change. When Vgs of the fourth thin film transistor T4 satisfies the formula: Vgs = V_A-Vdata = Vth, the fourth thin film transistor T4 is turned off, at this time the first connection point A stores Vdata + Vth.

In the T3 stage, the first scanning signal S1[n+1] of the next frame of the first polarity that is output by the first scanning signal circuit turns on the seventh thin film transistor T7, thereby resetting the anode of the display unit 6, and improving the life of the display unit 6.

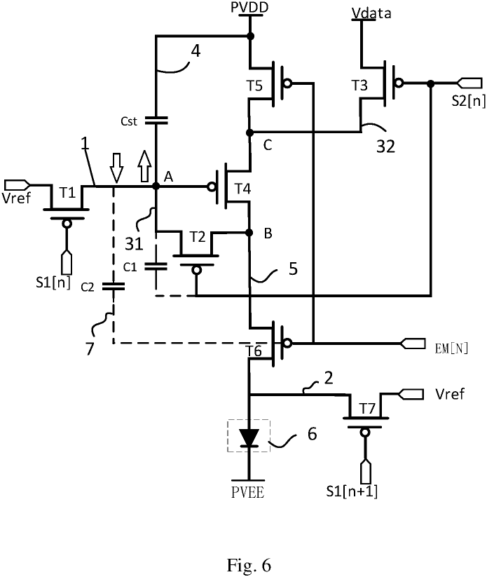

In the light-emitting stage of T4, the first scanning signal circuit outputs the first scanning signal S1[n] of the second polarity, and the first thin film transistor T1 is cut off. The second scanning signal circuit outputs the second scanning signal S2[n] of the second polarity, so that the second thin film transistor T2 and the third thin film transistor T3 are in the cut-off state, as shown in FIG. 6, the compensation circuit 3 does not work. When the compensation circuit 3 does not work, the parasitic capacitance C1 carried by the second thin film transistor T2 itself couples the second scanning signal S2[n] of the second polarity thatis output by the second scanning signal circuit to the first connection point A, resulting in upward fluctuations in the voltage of the first connection point A. The coupling balance circuit 7 couples the light-emitting control signal Emit of first polarity that is output by the light-emitting control signal circuit to the first connection point A, thereby balancing the fluctuation caused by the parasitic capacitance C1. At the same time, the memory circuit 4 outputs the data signal Vdata as a compensation signal to the first connection point A to continuously turn on the fourth thin film transistor T4. The light-emitting control signal circuit outputs the light-emitting control signal Emit of the first polarity, so that the fifth thin film transistor T5 and the sixth thin film transistor T6 are in the on state, the light-emitting circuit 5 works to drive the display unit 6 for light-emitting display. In this process, the fifth thin film transistor T5 and the sixth thin film transistor T6 are turned on, at this time the driving current of the display unit 6 is:

$$\begin{matrix}\text{I=} \text{1} / \text{2} \text{*K} \left(\text{Vgs-Vth}\right) \text{\textasciicircum 2=} \text{1} / \text{2} \text{*K} \left(\text{Vdata+Vth-PVDD-Vth}\right) \text{\textasciicircum 2=} \\ \text{1} / \text{2} \text{*K} \left(\text{Vdata-PVDD}\right) \text{\textasciicircum 2} \text{.}\end{matrix}$$

The driving current of the display unit 6 is independent of the threshold voltage of the fourth thin film transistor T4, which has a compensation effect. When the memory circuit 4 compensates the first connection point A and stabilizes the potential of the first connection point A, the coupling balance circuit 7 balances the voltage fluctuations caused by the parasitic capacitance C1, stabilizes the potential of the first connection point A, so that the brightness of the display unit 6 will not change during a frame display.

### Fourth Embodiment 4

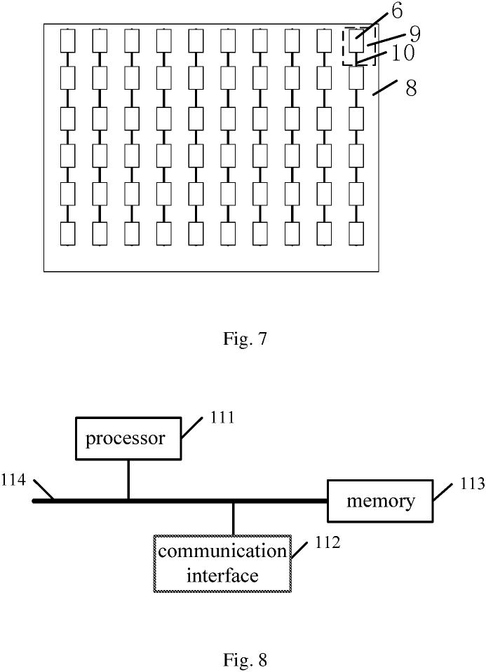

Embodiments of the present disclosure provide a display device 8, as shown in FIG. 7, the display device 8 comprises a substrate 8, a plurality of subpixels 9 are provided on the substrate 8. Each subpixel 9 comprises the display unit 6 and the driving circuit 10 of the display unit, and the driving circuit 10 of the display unit is connected to the display unit 6, the driving circuit of the display unit comprises but is not limited to: a first reset circuit 1; a second reset circuit 2; a compensation circuit 3; a memory circuit 4; a coupling balance circuit 7, a light-emitting circuit 5 and a first connection point A;
wherein the first reset circuit 1, the memory circuit 4, the light-emitting circuit 5, and the compensation circuit 3 are respectively connected to the first connection point A;
wherein one end of the coupling balance circuit 7 is connected between the first reset circuit 1 and the first connection point A, the display unit 6 is connected to the light-emitting circuit 5, and one end of the second reset circuit 2 is connected between the light-emitting circuit 5 and the display unit 6;
the first reset circuit 1 is configured to transmit a reset signal to the first connection point A to reset the memory circuit 4, and the second reset circuit 2 is configured to reset the display unit 6;
the compensation circuit 3 is configured to transmit a data signal Vdata to the first connection point A so that the memory circuit 4 stores the data signal Vdata, and the memory circuit 4 is configured to compensate the light-emitting circuit 5 using the data signal Vdata through the first connection point A when the compensation circuit 3 stops transmitting the data signal Vdata;
the light-emitting circuit 5 is configured to drive the display unit 6 to emit light;
the coupling balance circuit 7 is configured to couple a compensation signal to the first connection point A to compensate the first connection point A when the memory circuit 4 compensates the light-emitting circuit 5 through the first connection point A, thereby balancing a voltage fluctuation caused by an interference signal coupled to the first connection point A when the compensation circuit 3 stops transmitting the data signal Vdata.

In some embodiments, the display unit 6 comprises a red light display unit 6, a green light display unit 6, and a blue light display unit 6; or, the display unit 6 comprises a red light display unit 6, a green light display unit 6, a blue light display unit 6 and a yellow light display unit 6; or, the display unit 6 comprises a red light display unit 6, a green light display unit 6, a blue light display unit 6 and a white light display unit 6. The types of display units include, but are not limited to OLED display units.

### Fifth Embodiment

As shown in FIG. 8, embodiments of the present disclosure provide a display device, comprising a processor 111, a communication interface 112, a memory 113 and a communication bus 114, wherein the processor 111, the communication interface 112, and the memory 113 complete communication between each other through the communication bus 114.

The memory 113 is used for storing computer programs.

In some embodiments, the processor 111, for executing the program stored on the memory 113, implements the steps of the driving method of the display unit provided by any of the foregoing method embodiments.

In some embodiments, the present disclosure also provides a computer-readable storage medium. The computer-readable storage medium stores the computer program. The steps of the driving method of the display unit as provided by any of the foregoing method embodiments are implemented when the computer program is executed by the processor.

What needs illustration is that in this article, relational terms such as “first” and “second” are used only to distinguish one entity or operation from another, and do not necessarily require or imply any such actual relationship or order between these entities or operations. Furthermore, the terms “comprise”, “contain” or any other variation thereof are intended to cover non-exclusive inclusions, such that a process, method, object, or equipment that comprises a set of elements comprises not only those elements but also other elements that are not explicitly listed or that are inherent to the process, method, object, or equipment. Without further limitation, the elements qualified by the statement “comprising a...” do not exclude the existence of other identical elements in the process, method, article or apparatus comprising said elements.

The foregoing is only a specific embodiment of the present disclosure, so that one skilled in the art can understand or realize the present applicatio. A variety of modifications to these embodiments will be obvious to one skilled in the art, and the general principles defined herein may be implemented in other embodiments without departing from the spirit or scope of the present applicatio. Accordingly, the present applicatio will not be limited to these embodiments shown herein, but will conform to the widest range consistent with the principles and novelty features applied for herein.

What is claimed is:

1. A driving circuit of a display unit, comprising:
a first reset circuit;
a second reset circuit;
a compensation circuit;
a memory circuit;
a light-emitting circuit configured to drive a display unit to emit light;
a first connection point, wherein the first reset circuit, the memory circuit, the light-emitting circuit, and the compensation circuit are respectively connected to the first connection point;
a coupling balance circuit, wherein one end of the coupling balance circuit is connected between the first reset circuit and the first connection point, the display unit is connected to the light-emitting circuit, and one end of the second reset circuit is connected between the light-emitting circuit and the display unit;
the first reset circuit is configured to transmit a reset signal to the first connection point to reset the memory circuit, and the second reset circuit is configured to reset the display unit;
the compensation circuit is configured to transmit a data signal to the first connection point so that the memory circuit stores the data signal, and the memory circuit is configured to compensate the light-emitting circuit using the data signal through the first connection point when the compensation circuit stops transmitting the data signal; and
the coupling balance circuit is configured to couple a compensation signal to the first connection point to compensate the first connection point when the memory circuit compensates the light-emitting circuit through the first connection point, thereby balancing a voltage fluctuation caused by an interference signal coupled to the first connection point when the compensation circuit stops transmitting the data signal.

2. The driving circuit of the display unit according to claim 1, wherein the light-emitting circuit is configured to turn on according to a light-emitting control signal of a first polarity that is output by a light-emitting control signal circuit, to drive the display unit to emit light; and the compensation circuit is configured to turn on according to a second scanning signal of the first polarity that is output by a second scanning signal circuit; and
the compensation circuit is cut off according to the second scanning signal of a second polarity that is output by the second scanning signal circuit, and the second scanning signal of the second polarity that is output by the second scanning signal circuit is coupled to the first connection point when the compensation circuit is cut off.

3. The driving circuit of the display unit according to claim 2, wherein the coupling balance circuit comprises a compensation capacitance, the compensation capacitance is used to couple the light-emitting control signal of the first polarity that is output by the light-emitting control signal circuit as a compensation signal to the first connection point, thereby balancing a voltage fluctuation caused by coupling the second scanning signal of the second polarity that is output by the second scanning signal circuit to the first connection point by the compensation circuit; and the light-emitting control signal of the first polarity that is output by the light-emitting control signal circuit and the second scanning signal of the second polarity that is output by the second scanning signal circuit are signals with opposite electrode polarity.

4. The driving circuit of the display unit according to claim 1, wherein the compensation circuit comprises a first compensation circuit and a second compensation circuit, a node connecting the first compensation circuit and the light-emitting circuit is a second connection point, and a node connecting the second compensation circuit and the light-emitting circuit is a third connection point; and
the second compensation circuit is configured to transmit the data signal to the third connection point, to transmit to the second connection point through the light-emitting circuit, and the first compensation circuit is configured to transmit the data signal from the second connection point to the first connection point.

5. The driving circuit of the display unit according to claim 1, wherein the first reset circuit comprises a first thin film transistor, and a control terminal of the first thin film transistor is connected to the first scanning signal circuit; a first end of the first thin film transistor is connected to a reference voltage, and a second end of the first thin film transistor is connected to the first connection point; and when the first thin film transistor is turned on, the reference voltage is transmitted to the first connection point to reset the memory circuit and the light-emitting circuit.

6. The driving circuit of the display unit according to claim 5, wherein the second reset circuit comprises a seventh thin film transistor, and a control terminal of the seventh thin film transistor is connected to the first scanning signal circuit; a first end of the seventh thin film transistor is connected to the reference voltage, and a second end of the seventh thin film transistor is arranged between the light-emitting circuit and the display unit; and when the seventh thin film transistor is turned on, the reference voltage is transmitted to the display unit to reset the display unit.

7. The driving circuit of the display unit according to claim 4, wherein the first compensation circuit comprises a second thin film transistor, and a control terminal of the second thin film transistor is connected to the second scanning signal circuit; a first end of the second thin film transistor is connected to the second connection point, and a second end of the second thin film transistor is connected to the first connection point; and when the first compensation circuit is turned on, the data signal is transmitted from the second connection point to the first connection point.

8. The driving circuit of the display unit according to claim 7, wherein the second compensation circuit comprises a third thin film transistor, and a control terminal of the third thin film transistor is connected to the second scanning signal circuit; a first end of the third thin film transistor is connected to the data signal, and a second end of the third thin film transistor is connected to the third connection point; and when the second compensation circuit is turned on, the data signal is transmitted to the third connection point.

9. The driving circuit of the display unit according to claim 3, wherein the light-emitting circuit comprises a fourth thin film transistor, a fifth thin film transistor, and a sixth thin film transistor;
a control terminal of the fourth thin film transistor is connected to the first connection point, a first end of the fourth thin film transistor is connected to the third connection point, and a second end of the fourth thin film transistor is connected to the second connection point;
control terminals of the fifth thin film transistor and the sixth thin film transistor are connected to the light-emitting control signal circuit, a first end of the fifth thin film transistor is connected to a high voltage signal input terminal, and a second end of the fifth thin film transistor is connected to the third connection point; and a first end of the sixth thin film transistor is connected to the second connection point, and a second end of the sixth thin film transistor is connected to the display unit; and
when the fourth thin film transistor, the fifth thin film transistor, and the sixth thin film transistor are turned on, a current flows from the high voltage signal input terminal to a low voltage signal input terminal that is connected to the display unit, thereby driving the display unit to emit light.

10. The driving circuit of the display unit according to claim 9, wherein the fourth thin film transistor, the fifth thin film transistor, and the sixth thin film transistor are all N-type thin film transistors.

11. The driving circuit of the display unit according to claim 1, wherein the memory circuit is provided with a storage capacitance, and the storage capacitance is used to store the data signal.

12. A driving method of a display unit, wherein the driving method is applied to a driving circuit of the display unit, the driving circuit of a display unit comprises: a first reset circuit; a second reset circuit; a compensation circuit; a memory circuit; a light-emitting circuit configured to drive a display unit to emit light;
a first connection point, wherein the first reset circuit, the memory circuit, the light-emitting circuit, and the compensation circuit are respectively connected to the first connection point;
a coupling balance circuit, wherein one end of the coupling balance circuit is connected between the first reset circuit and the first connection point, the display unit is connected to the light-emitting circuit, and one end of the second reset circuit is connected between the light-emitting circuit and the display unit;
the first reset circuit is configured to transmit a reset signal to the first connection point to reset the memory circuit, and the second reset circuit is configured to reset the display unit;
the compensation circuit is configured to transmit a data signal to the first connection point so that the memory circuit stores the data signal, and the memory circuit is configured to compensate the light-emitting circuit using the data signal through the first connection point when the compensation circuit stops transmitting the data signal;
the coupling balance circuit is configured to couple a compensation signal to the first connection point to compensate the first connection point when the memory circuit compensates the light-emitting circuit through the first connection point, thereby balancing a voltage fluctuation caused by an interference signal coupled to the first connection point when the compensation circuit stops transmitting the data signal;
the driving method comprises:
in a reset stage, a reset signal is transmitted to a first connection point through a first reset circuit, to reset a memory circuit, and a display unit is reset by a second reset circuit;
in a compensation stage, a data signal is transmitted to the first connection point by a compensation circuit so that the memory circuit stores the data signal; and when the compensation circuit stops transmitting the data signal, the data signal is transmitted to the first connection point by the memory circuit, and the data signal is used to compensate a light-emitting circuit;
in a light-emitting stage, the display unit is driven by the light-emitting circuit to emit light; and when the memory circuit compensates the light-emitting circuit through the first connection point, the first connection point is compensated by coupling a compensation signal to the first connection point through a coupling balance circuit, thereby balancing a voltage fluctuation caused by an interference signal coupled to the first connection point when the compensation circuit stops transmitting the data signal.

13. The driving method of the display unit according to claim 12, wherein the first connection point is compensated by coupling the compensation signal to the first connection point through the coupling balance circuit, thereby balancing the voltage fluctuations caused by the interference signal coupled to the first connection point when the compensation circuit stops transmitting the data signal, comprises:
according to the coupling balance circuit, a light-emitting control signal of a first polarity that is output by a light-emitting control signal circuit is coupled to the first connection point as a compensation signal, thereby balancing the voltage fluctuation caused by coupling a second scanning signal of a second polarity that is output by a second scanning signal circuit to the first connection point by the compensation circuit.

14. The driving method of the display unit according to claim 13, wherein the light-emitting control signal of the first polarity that is output by the light-emitting control signal circuit and the second scanning signal of the second polarity that is output by the second scanning signal circuit are signals with opposite electrode polarity.

15. A display device, comprising:
a substrate; and
a plurality of sub-pixels on the substrate, wherein each of the plurality of sub-pixel comprises a display unit and a driving circuit of the display unit, and the driving circuit of the display unit is connected to the display unit, the driving circuit of a display unit comprises: a first reset circuit; a second reset circuit; a compensation circuit; a memory circuit; a light-emitting circuit configured to drive a display unit to emit light;
a first connection point, wherein the first reset circuit, the memory circuit, the light-emitting circuit, and the compensation circuit are respectively connected to the first connection point;
a coupling balance circuit, wherein one end of the coupling balance circuit is connected between the first reset circuit and the first connection point, the display unit is connected to the light-emitting circuit, and one end of the second reset circuit is connected between the light-emitting circuit and the display unit;
the first reset circuit is configured to transmit a reset signal to the first connection point to reset the memory circuit, and the second reset circuit is configured to reset the display unit;
the compensation circuit is configured to transmit a data signal to the first connection point so that the memory circuit stores the data signal, and the memory circuit is configured to compensate the light-emitting circuit using the data signal through the first connection point when the compensation circuit stops transmitting the data signal; and
the coupling balance circuit is configured to couple a compensation signal to the first connection point to compensate the first connection point when the memory circuit compensates the light-emitting circuit through the first connection point, thereby balancing a voltage fluctuation caused by an interference signal coupled to the first connection point when the compensation circuit stops transmitting the data signal.

16. The driving method of the display unit according to claim 15, wherein the display unit comprises a red light display unit, a green light display unit and a blue light display unit;
or, the display unit comprises a red light display unit, a green light display unit, a blue light display unit and a yellow light display unit;
or, the display unit comprises a red light display unit, a green light display unit, a blue light display unit and a white light display unit.
